(19) United States
(12) Patent Application Publication
(10) Pub. No.: US 2025/0021878 A1
(43) Pub. Date: Jan. 16, 2025

(54) METHOD AND APPARATUS, COMPUTER DEVICE, AND STORAGE MEDIUM FOR AN AUGMENTED SAMPLE

(71) Applicant: Beijing Volcano Engine Technology Co., Ltd., Beijing (CN)

(72) Inventors: Guolong SONG, Beijing (CN); Xuan LUO, Beijing (CN)

(21) Appl. No.: 18/764,952

(22) Filed: Jul. 5, 2024

(30) Foreign Application Priority Data
Jul. 10, 2023 (CN) 202310842663.7

(51) Int. Cl. G06N 20/00

(52) U.S. Cl. CPC G06N 20/00

(57) ABSTRACT

The present invention relates to the technical field of data processing, and discloses a method and apparatus, computer device, and storage medium for generating an augmented sample. The method includes: obtaining a reference sample set to be augmented, and selecting at least two parent samples from the reference sample set; generating a new sample based on the at least two parent samples; updating feature values of the first type of features based on first statistical data of the first type of features in the reference sample set, and updating classification options of the second type of features based on second statistical data of the second type of features in the reference sample set; and generating an augmented sample based on the updated feature values of the first type of features and the updated classification options of the second type of features.

### CROSS-REFERENCE TO RELATED APPLICATION(S)

This application claims priority to Chinese Application No. 202310842663.7 filed Jul. 10, 2023, the disclosure of which is incorporated herein by reference in its entity.

### FIELD

The present disclosure relates to the technical field of data processing, and specifically relates to a method and apparatus, computer device, and storage medium for generating an augmented sample.

### BACKGROUND

A classification model is a common supervised machine learning model, which is trained based on labeled samples. Through the classification model, data inputted therein can be classified into different categories. The classification model is widely applied to different fields. For example, in a scenario of information flow recommendation, news is classified into a plurality of categories such as finance, technology, and sports based on characteristic information such as news headlines and content.

However, limited by the limited number of samples and labeling costs, there may be insufficient labeled samples, making it difficult for the classification model to accurately classify. To solve the problem, a sample augmentation method is currently adopted to increase the number of samples. But the samples augmented by the current sample augmentation method are limited, making it difficult to ensure sample diversity, which still affects a classification effect of the classification model.

### SUMMARY

In view of this, embodiments of the present disclosure provide a method and apparatus, computer device, and storage medium for generating an augmented sample, so as to solve the problem of difficulty in augmenting diverse samples.

In a first aspect, an embodiment of the present disclosure provides a method for generating an augmented sample, including: obtaining a reference sample set to be augmented, and selecting at least two parent samples from the reference sample set; generating a new sample based on the at least two parent samples, where the new sample at least includes a first type of features and a second type of features; updating feature values of the first type of features based on first statistical data of the first type of features in the reference sample set, and updating classification options of the second type of features based on second statistical data of the second type of features in the reference sample set; and generating an augmented sample based on updated feature values of the first type of features and updated classification options of the second type of features.

According to the augmented sample generation method provided by this embodiment of the present disclosure, the at least two required parent samples are screened from the reference sample set to generate the new sample, and the first type of features and the second type of features included in the new sample are updated, thereby updating the different types of features and generating the augmented sample. Therefore, sample augmentation can be performed in conjunction with the different types of features, thereby ensuring diversity of the augmented sample, and further enhancing a classification training effect of a classification model.

In a second aspect, an embodiment of the present disclosure provides an augmented sample generation apparatus, including: a sample set obtaining unit, configured to obtain a reference sample set to be augmented, and select at least two parent samples from the reference sample set; a new sample generation unit, configured to generate a new sample based on the at least two parent samples, where the new sample at least includes a first type of features and a second type of features; a feature update unit, configured to update feature values of the first type of features based on first statistical data of the first type of features in the reference sample set, and update classification options of the second type of features based on second statistical data of the second type of features in the reference sample set; and an augmented sample generation unit, configured to generate an augmented sample based on updated feature values of the first type of features and updated classification options of the second type of features.

In a third aspect, an embodiment of the present disclosure provides an electronic device, including a memory and a processor. The memory and the processor are in mutual communication connection. The memory stores computer instructions. The processor executes the computer instructions to perform the augmented sample generation method in the first aspect or any one of the corresponding implementations.

In a fourth aspect, an embodiment of the present disclosure provides a computer-readable storage medium. The computer-readable storage medium stores computer instructions. The computer instructions are configured to enable a computer to perform the augmented sample generation method in the first aspect or any one of the corresponding implementations.

### BRIEF DESCRIPTION OF THE DRAWINGS

In order to describe technical solutions in specific implementations of the present invention or the prior art more clearly, accompanying drawings required to be used in the descriptions of the specific implementations or the prior art will be simply introduced below, obviously, the accompanying drawings described below are some implementations of the present invention, and those of ordinary skill in the art can obtain other accompanying drawings according to these accompanying drawings without creative work.

FIG. 1 is a schematic flowchart of an augmented sample generation method according to an embodiment of the present invention;

FIG. 2 is a schematic flowchart of another augmented sample generation method according to an embodiment of the present invention;

FIG. 3 is a schematic flowchart of yet another augmented sample generation method according to an embodiment of the present invention;

FIG. 4 is a structural block diagram of an augmented sample generation apparatus according to an embodiment of the present invention; and

FIG. 5 is a schematic diagram of a hardware structure of a computer device according to an embodiment of the present invention.

### DETAILED DESCRIPTION OF EMBODIMENTS

To make objectives, technical solutions, and advantages of embodiments of the present invention more clear, the technical solutions in the embodiments of the present invention are clearly and completely described in conjunction with the accompanying drawings in the embodiments of the present invention as below, and it is apparent that the described embodiments are only a part rather all of embodiments of the present invention. Based on the embodiments of the present invention, all other embodiments obtained by those skilled in the art without creative labor shall fall within the scope of protection of the present invention.

In the related art, there are mainly three types of labeled sample augmentation methods:

(1) Augmentation based on unlabeled samples. Specifically, based on an unlabeled sample set and a limited labeled sample set, unlabeled samples and labeled samples that are close are found through a feature space metric function. Meanwhile, when certain conditions are satisfied, labels of the labeled samples are assigned to the unlabeled samples, turning the latter into labeled samples, thereby achieving sample augmentation.

(2) Augmentation through image transformation. In an image classification task, operations such as random cropping and random rotation are performed on labeled images to generate new samples. Meanwhile, labels of the new samples inherit labels of original samples, thereby achieving sample augmentation.

(3) Augmentation using an embedding method. In a natural language processing (NLP) classification task, text features are first subjected to embedding, and then embedding features are subjected to random drop to discard certain features, thereby forming new sample embedding features. Meanwhile, labels of new samples inherit labels of original samples, thereby achieving sample augmentation.

However, most of the above sample augmentation methods involve using the existing unlabeled sample or performing transformations on the original labeled sample, without considering the types of sample features, and as a result, the diversity of augmented samples is limited, affecting a subsequent model effect. Moreover, the above methods have certain limitations, and if there is no referable unlabeled sample set, the methods are not suitable for samples with non-image and non-embedding features. In addition, there is a lack of effective quality assessment for augmented samples.

Based on this, the technical solution of the present disclosure combines different types of features for sample augmentation, ensuring diversity of the augmented samples, and can adapt to various types of features without being limited by the unlabeled sample set, thereby further improving a classification training effect of the classification model.

According to an embodiment of the present invention, an embodiment of an augmented sample generation method is provided. It should be noted that steps shown in flowcharts of the accompanying drawings may be performed in a computer system, such as a set of computer executable instructions. In addition, although a logical sequence is shown in the flowcharts, the illustrated or described steps may be performed in a different sequence than presented here in some cases.

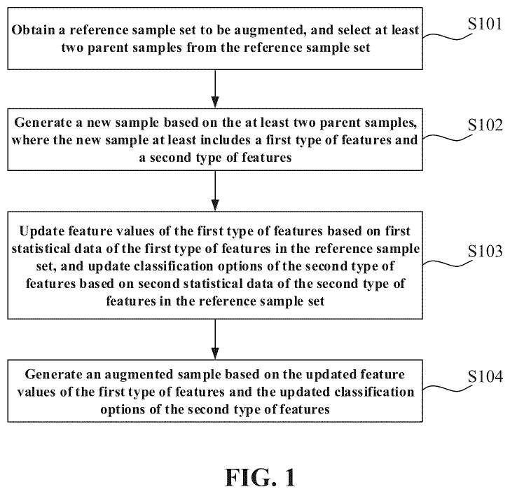

In this embodiment, a method for generating an augmented sample is provided, which may be used in a computer device, such as a computer and a server. FIG. 1 is a flowchart of an augmented sample generation method according to an embodiment of the present invention. As shown in FIG. 1, the process includes the following steps:

Step S101: a reference sample set to be augmented is obtained, and at least two parent samples are selected from the reference sample set.

The reference sample set is a collection of a plurality of reference samples, and all the reference samples included in the reference sample set belong to the same category. From the reference sample set, the plurality of reference samples belonging to the same category may be obtained by recognizing labels of samples through a classification model.

The parent samples are reference samples used for generating new samples. After obtaining the reference sample set, category prediction is performed on each reference sample in the reference sample set. Based on category prediction results of the reference samples, two or more parent samples are selected from the reference sample set to be augmented.

Step S102: a new sample is generated based on the at least two parent samples, where the new sample at least includes a first type of features and a second type of features.

The new sample is a combined sample obtained through cross processing of the parent samples. The new sample includes features of the at least two parent samples. Therefore, the new sample at least includes the first type of features and the second type of features. The first type of features and the second type of features come from different parent samples, and have different features to be represented.

Taking two parent samples with classification labels y in a scenario of information flow as an example, the first type of features may represent a traffic flow for the content of the information flow, such as the number of video plays and the number of video completions, which is extracted from one parent sample; and the second type of features may represent a classification for the content of the information flow, such as animation, news, and beauty makeup, which is extracted from another parent sample. Therefore, new features can be generated through cross combination of the features of the two parent samples, and the new sample is generated in conjunction with the classification label y.

Step S103: feature values of the first type of features are updated based on first statistical data of the first type of features in the reference sample set, and classification options of the second type of features are updated based on second statistical data of the second type of features in the reference sample set.

The first statistical data represents distribution statistical data of the feature values of the first type of features. By analyzing the feature values corresponding to the first type of features in the reference sample set, the distribution statistical data for the feature values can be obtained. The feature values corresponding to the first type of features are processed in conjunction with the distribution statistical data to update the feature values of the first type of feature.

The second statistical data represents probability statistics of the classification options of the second type of feature. By analyzing the classification options corresponding to the second type of features in the reference sample set, the probability statistical data for each classification option can be obtained. The classification options corresponding to the second type of features are processed in conjunction with the probability statistical data to update the feature values of the second type of feature.

Step S104: an augmented sample is generated based on updated feature values of the first type of features and updated classification options of the second type of features.

The first type of features with the updated feature values and the second type of features with updated classification options are combined to generate the augmented sample. The augmented sample has both the updated first type of features and the updated second type of features.

According to the augmented sample generation method provided by this embodiment of the present disclosure, the at least two required parent samples are screened from the reference sample set to generate the new sample, and the first type of features and the second type of features included in the new sample are updated, thereby updating the different types of features and generating the augmented sample. Therefore, sample augmentation can be performed in conjunction with the different types of features, thereby ensuring diversity of the augmented sample, and further enhancing the classification effect of the classification model.

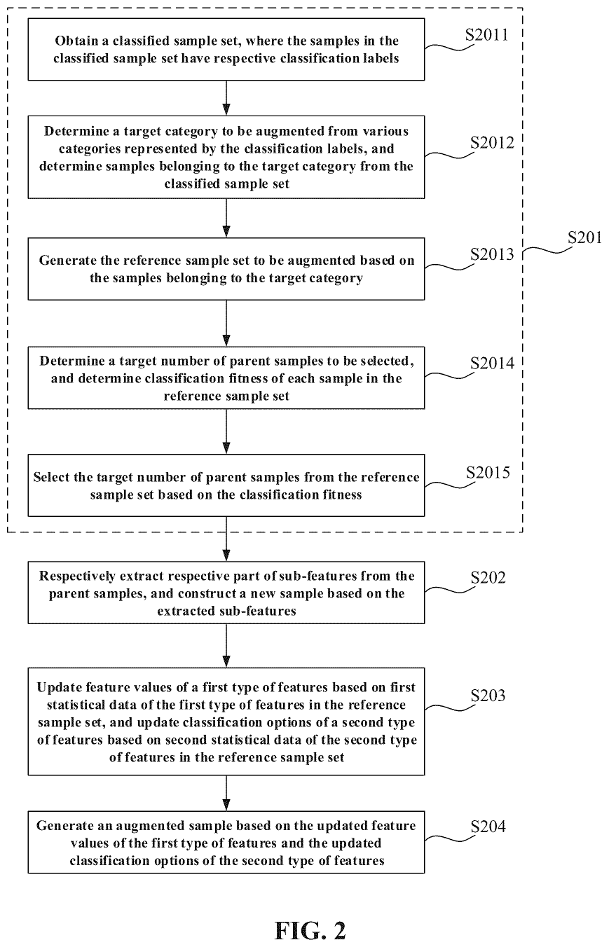

In this embodiment, a method for generating an augmented sample is provided, which may be used in a computer device, such as a computer and a server. FIG. 2 is a flowchart of an augmented sample generation method according to an embodiment of the present invention. As shown in FIG. 2, the process includes the following steps:

Step S201: a reference sample set to be augmented is obtained, and at least two parent samples are selected from the reference sample set.

Specifically, step S201 may include:

Step S2011: a classified sample set is obtained, where the samples in the classified sample set have respective classification labels.

The classified sample set is an initially-constructed set of samples with classification labels, and the classification labels are category identifiers assigned to the samples. Specifically, the classified sample set is composed of pre-collected samples of various categories, and each sample is pre-labeled with a corresponding classification label. Taking images as an example, the classified sample set may include images of various categories, such as a character image, a landscape image, a high-quality image, a medium-quality image, and a blurry image.

Step S2012: a target category to be augmented is determined from various categories represented by the classification labels, and samples belonging to the target category are determined from the classified sample set.

As mentioned above, the classified sample set includes the plurality of samples, the categories of the plurality of samples are diverse, and each category is represented by the corresponding classification label. The target category to be augmented is a specific category that needs augmentation, such as augmenting the category of the character image.

Specifically, after determining the various categories represented by the classification labels, a certain category may be selected from the various categories as an augmentation target. Correspondingly, the selected category is used as the target category, and all samples belonging to the target category are extracted from the classified sample set.

Step S2013: a reference sample set to be augmented is generated based on the samples belonging to the target category.

The reference sample set is a subset divided from the classified sample set, which is specifically a sample set belonging to the target category. Therefore, by combining all the samples belonging to the target category, the reference sample set corresponding to the target category can be formed.

Step S2014: a target number of parent samples to be selected is determined, and classification fitness of each sample in the reference sample set is determined.

The parent samples are used for generating a new sample. The target number of the parent samples is preset, such as 2, 3, and 4. The specific number may be determined in conjunction with the types of features of the parent samples. For example, if the parent samples have two types of features, to ensure cross processing to generate a new sample, the target number of parent samples to be selected may be set to 2. Similarly, if the parent samples have three types of features, the target number of parent samples to be selected may be set to 3.

The classification fitness represents the probability of predicting the category of each sample as the target category. The classification fitness may be determined in conjunction with prediction results of the classification model. Specifically, the step of determining classification fitness of each sample in the reference sample set includes:

Step a1: for any target sample in the reference sample set, the target sample is predicted based on a preset classification model to generate classification probability information indicating that the target sample is classified into a target category to be augmented, where the preset classification model is trained based on a classified sample set to which the reference sample set belongs.

Step a2: classification fitness of the target sample is generated based on the classification probability information.

The classified sample set includes a plurality of labeled samples, and model training is performed in conjunction with the labeled samples to generate the preset classification model. The preset classification model may be a machine learning model such as logistic regression (LR) and a support vector machine (SVM), or a deep learning model such as deep neural Networks (DNNs) or bidirectional encoder representations from transformers (Bert), which is not specifically limited here, and may be determined by those skilled in the art according to actual needs.

There are a plurality of samples in the reference sample set. For any target sample, the preset classification model obtained through training is adopted to predict the classification probability information of the target sample so as to determine the probability of the target sample belonging to the target category. The classification fitness of the target sample is numerically the same as the classification probability corresponding to the target sample.

Specifically, if the target sample is Si(Xi, y), Xi represents sample features of the target sample, and the sample features at least include a first type of features and a second type of features; and y represents a classification label of the target sample, and is used for representing a target category. Classification prediction is performed on the target sample according to the preset classification model to obtain a prediction result predict_Xi, and a classification probability p(predict_Xi==y) of the target category corresponding to the predicted classification label y is determined, thereby determining the classification fitness of the target sample as fit_score(Si)=p(predict_Xi==y).

Step S2015: the target number of parent samples are selected from the reference sample set based on the classification fitness.

The calculated classification fitness is used as the sampling probability, and the samples in the reference sample set are randomly sampled according to the sampling probability, thereby obtaining the corresponding target number of parent samples: S1(X1, y), S2(X2, y), . . . , Sj(Xj, y).

Step S202: a new sample is generated based on the at least two parent samples, where the new sample at least includes a first type of features and a second type of features.

Specifically, step S202 may include: respective part of sub-features are respectively extracted from the parent samples, and the new sample is constructed based on the extracted sub-features.

The part of sub-features are respectively extracted from the parent samples, and the part of sub-features extracted from the parent samples are different, and therefore the different part of sub-features may be combined into new sample features, and the new sample features are combined with the classification label y to construct the new sample.

Specifically, taking two parent samples as an example, according to a set proportion, part of sub-features may be selected from a sample feature X1 (a1, b1, A1, B1) of the parent sample S1(X1, y), and part of sub-features may be selected from a sample feature X2 (a2, b2, A2, B2) of S2(X2, y). By combining the two parts of sub-features, a new sample feature Xnew is generated, and then is combined with the classification label y to generate a new sample Snew(Xnew, y).

a1 and b1 are the first type of features from the sample feature X1; A1 and B1 are the second type of features from the sample feature X1; a2 and b2 are the first type of features from the sample feature X2; A2 and B2 are the second type of features from the sample feature X2. If the first type of features a1 and b1 are extracted from the sample feature X1, and the second type of features A2 and B2 are extracted from the sample feature X2, Xnew (a1, b1, A2, B2) can be obtained through combination.

Step S203: feature values of the first type of features are updated based on first statistical data of the first type of features in the reference sample set, and classification options of the second type of features are updated based on second statistical data of the second type of features in the reference sample set. For detailed descriptions, reference is made to relevant descriptions in the foregoing embodiments, which are not repeated here.

Step S204: an augmented sample is generated based on updated feature values of the first type of features and updated classification options of the second type of features. For detailed descriptions, reference is made to relevant descriptions in the foregoing embodiments, which are not repeated here.

According to the augmented sample generation method provided by this embodiment of the present disclosure, the samples of the target category to be augmented are determined through the sample classification labels in the classified sample set, thereby augmenting the samples of the target category. Using the classification fitness as a reference, the required target number of parent samples are selected from the reference samples, making the screened parent samples more accurate. By using the preset classification model to predict the classification probability information of any target sample in the reference sample set, the corresponding classification fitness is determined according to the classification probability information, and therefore the parent samples can be selected from the reference sample set in conjunction with the classification fitness to generate the new sample.

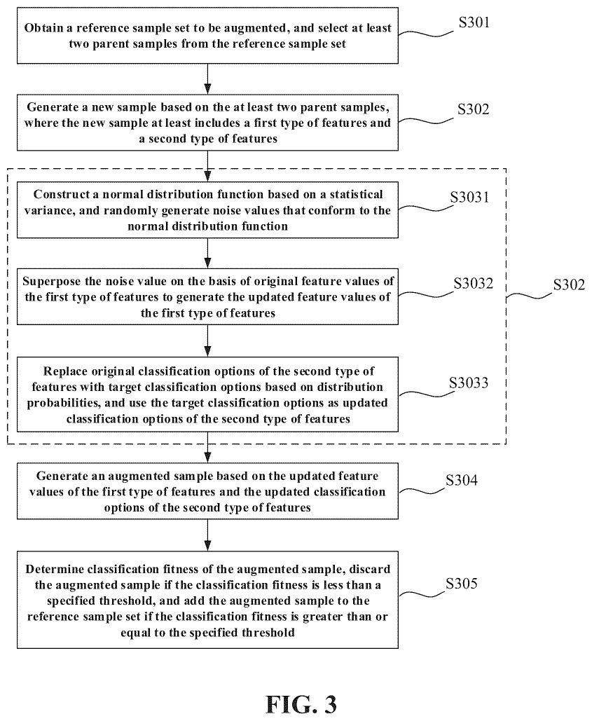

In this embodiment, a method for generating an augmented sample is provided, which may be used in a computer device, such as a computer and a server. FIG. 3 is a flowchart of an augmented sample generation method according to an embodiment of the present invention. As shown in FIG. 3, the process includes the following steps:

Step S301: a reference sample set to be augmented is obtained, and at least two parent samples are selected from the reference sample set. For detailed descriptions, reference is made to relevant descriptions in the foregoing embodiments, which are not repeated here.

Step S302: a new sample is generated based on the at least two parent samples, where the new sample at least includes a first type of features and a second type of features. For detailed descriptions, reference is made to relevant descriptions in the foregoing embodiments, which are not repeated here.

Step S303: feature values of the first type of features are updated based on first statistical data of the first type of features in the reference sample set, and classification options of the second type of features are updated based on second statistical data of the second type of features in the reference sample set.

Specifically, the first type of features may be a numerical feature, and the first statistical data represents a statistical variance of the first type of features in the reference sample set. The second type of features may be a classification option feature, and the second statistical data represents a distribution probability of each classification option in the second type of features in the reference sample set. Correspondingly, step S303 may include:

Step S3031: a normal distribution function is constructed based on a statistical variance, and noise values that conform to the normal distribution function are randomly generated.

The mean of the normal distribution function is 0. The first type of features is the numerical feature, and therefore statistical analysis may be performed on the first type of features in the sample features of various reference samples in the reference sample set to determine the statistical variance specific to the first type of features. The normal distribution function may be constructed in conjunction with the statistical variance to make the first type of features conform to a normal distribution. Meanwhile, random noise values conforming to the normal distribution function are generated, such as using an inverse function of the normal distribution function, box-muller transformation, and other methods to generate random noise values that conform to the normal distribution function.

Step S3032: the noise value is superposed on the basis of original feature values of the first type of features to generate the updated feature values of the first type of features.

For the first type of features in the sample feature Xnew of the new sample Snew (Xnew, y), noise values are superimposed with a specified probability based on the feature values to generate an updated feature value. For example, the sample feature Xnew of the new sample Snew is (10, 9, A, B), where 10 and 9 represent the original feature values of the first type of features, 10 represents the number of video plays, and 9 represents the number of video completions. By adding the noise value of −1 to the original feature values, the sample feature X′new (9, 8, A, B) with the updated feature values can be obtained.

By superimposing the noise value from the normal distribution function onto the original feature values of the first type of features, an update of the first type of features can be achieved. Therefore, new sample variation can be performed in conjunction with the feature values of the first type of features, such that the updated first type of features and the first type of features before the update have feature consistency.

Step S3033: original classification options of the second type of features are replaced with target classification options based on the distribution probabilities, and the target classification options are used as updated classification options of the second type of features.

The second type of features of various reference samples in the reference sample set are analyzed to determine distribution probabilities of categories corresponding to the second type of features. The target classification options for replacing the original classification options are randomly sampled based on the distribution probabilities of the categories.

For the second type of features in the sample feature Xnew of the new sample Snew (Xnew, y), based on the original classification options, the original classification options are replaced with the target classification options with a specified probability, thereby generating updated classification options.

For example, the sample feature Xnew of the new sample Snew is (10, 9, A, B), where A and B represent the original classification options of the second type of features, A represents animation, and B represents the beauty makeup. If the classification options included in the reference sample set are respectively animation, beauty makeup, sports, news, and entertainment, with corresponding distribution probabilities of 10%, 25%, 15%, 20%, and 30% respectively. The target classification options randomly determined according to the distribution probabilities are the sports and the entertainment, and therefore the animation and the beauty makeup may be replaced with the sports and the entertainment, and accordingly the sample feature X″new (10, 9, A1, B1) with updated classification options can be obtained.

Of course, the replacement of the classification options corresponding to the second type of features may also be performed based on the sample feature X′new (9, 8, A, B) with the updated feature values, so as to generate a sample feature with updated feature values and classification options.

By updating the second type of features through the distribution probabilities, new sample variation can be performed in conjunction with the second type of features, and therefore, the updated second type of features and the second type of features before the update have classification feature consistency.

Step S304: an augmented sample is generated based on updated feature values of the first type of features and updated classification options of the second type of features. For detailed descriptions, reference is made to relevant descriptions in the foregoing embodiments, which are not repeated here.

Step S305: classification fitness of the augmented sample is determined, and if the classification fitness is less than a specified threshold, the augmented sample is discarded; and if the classification fitness is greater than or equal to the specified threshold, the augmented sample is added to the reference sample set.

After determining the augmented sample, the corresponding classification fitness is calculated for the augmented sample. By comparing the classification fitness of the augmented sample with the specified threshold, a relationship between the classification fitness and the specified threshold is determined. When the classification fitness is less than the specified threshold, it indicates that the augmented sample does not meet requirements, and the augmented sample is discarded. When the classification fitness is greater than or equal to the specified threshold, it indicates that the augmented sample meets the requirements, and in this case, the augmented sample is added to the reference sample set.

Specifically, the step of determining classification fitness of the augmented sample includes:
Step b1: a target category corresponding to the reference sample set is determined, and the augmented sample is predicted based on the preset classification model to generate classification probability information indicating that the augmented sample is classified into the target category.

Step b2: classification fitness of the augmented sample is generated based on the classification probability information.

The target category corresponding to the reference sample set may be determined based on the classification labels of the reference samples in the reference sample set. The preset classification model trained above is adopted to perform classification prediction on the augmented sample so as to predict the target category to which the augmented sample belongs, and determine the classification probability information for the target category, and the classification probability information is determined as the classification fitness of the augmented sample.

By predicting the classification probability information corresponding to the augmented sample through the preset classification model, the classification fitness can be determined, thereby improving elimination accuracy of the new sample.

According to the augmented sample generation method provided by this embodiment of the present disclosure, by extracting the part of sub-features from the parent samples and constructing the new sample through the sub-features extracted from the various parent samples, the new sample has a plurality of features, thereby improving feature diversity of the new sample. By detecting the classification fitness and the specified threshold of the augmented sample, whether the augmented sample needs to be discarded is determined, thereby achieving selective elimination of the new sample, and facilitating further improvement in the augmentation effect of the new sample.

The embodiments further provide an augmented sample generation apparatus. The apparatus is configured to implement the foregoing embodiments and preferred implementations, and details that have been described are not repeated. As used below, the term “module” may implement combination of software and/or hardware with preset functions. Apparatuses described in the following embodiments are preferably implemented by the software, but it is possible and conceivable for implementing the apparatuses through the hardware or combination of the software and the hardware.

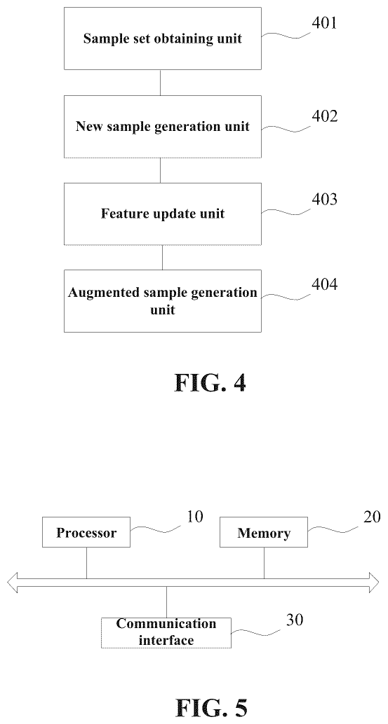

This embodiment provides an augmented sample generation apparatus, as shown in FIG. 4, including:
a sample set obtaining unit 401, configured to obtain a reference sample set to be augmented, and select at least two parent samples from the reference sample set;
a new sample generation unit 402, configured to generate a new sample based on the at least two parent samples, where the new sample at least includes a first type of features and a second type of features;
a feature update unit 403, configured to update feature values of the first type of features based on first statistical data of the first type of features in the reference sample set, and update classification options of the second type of features based on second statistical data of the second type of features in the reference sample set; and
an augmented sample generation unit 404, configured to generate an augmented sample based on updated feature values of the first type of features and updated classification options of the second type of features.

In some optional implementations, the sample set obtaining unit 401 may include:
a classified sample set obtaining subunit, configured to obtain a classified sample set, where the samples in the classified sample set have respective classification labels;
a target category determining subunit, configured to determine a target category to be augmented from various categories represented by the classification labels, and determine samples belonging to the target category from the classified sample set;
a generation subunit, configured to generate a reference sample set to be augmented based on the samples belonging to the target category;
a fitness determining subunit, configured to determine a target number of parent samples to be selected, and determine classification fitness of each sample in the reference sample set; and
a parent sample selection subunit, configured to select the target number of parent samples from the reference sample set based on the classification fitness.

Specifically, the fitness determining subunit is specifically configured to: predict, for any target sample in the reference sample set, the target sample based on a preset classification model to generate classification probability information indicating that the target sample is classified into the target category to be augmented, where the preset classification model is trained based on the classified sample set to which the reference sample set belongs; and generate classification fitness of the target sample based on the classification probability information.

In some optional implementations, the new sample generation unit 402 may include:
a feature extraction subunit, configured to respectively extract respective part of sub-features from the parent samples, and construct a new sample based on the extracted sub-features.

In some optional implementations, the first statistical data represents a statistical variance of the first type of features in the reference sample set. The second statistical data represents a distribution probability of each classification option in the second type of features in the reference sample set. The feature update unit 403 may include:
a noise generation subunit, configured to construct a normal distribution function based on a statistical variance, and randomly generate noise values that conform to the normal distribution function;
a noise superposition subunit, configured to superpose the noise value on the basis of original feature values of the first type of features to generate the updated feature values of the first type of features; and
a replacement subunit, configured to replace original classification options of the second type of features with target classification options based on the distribution probabilities, and use the target classification options as updated classification options of the second type of features.

In some optional implementations, the above augmented sample generation apparatus may further include:
an elimination selection unit, configured to determine classification fitness of the augmented sample, discard the augmented sample if the classification fitness is less than a specified threshold, and add the augmented sample to the reference sample set if the classification fitness is greater than or equal to the specified threshold.

In some optional implementations, the elimination selection unit may include:
a prediction subunit, configured to determine a target category corresponding to the reference sample set, and predict the augmented sample based on the preset classification model to generate classification probability information indicating that the augmented sample is classified into the target category; and
a classification fitness generation subunit, configured to generate classification fitness of the augmented sample based on the classification probability information.

Further functional descriptions of the various modules and units mentioned above are the same as the above corresponding embodiments, which are not repeated here.

The augmented sample generation apparatus in this embodiment is presented in the form of a functional unit. The unit refers to an application specific integrated circuit (ASIC), a processor and a memory executing one or more software programs or fixed programs, and/or other devices that can provide the above functions.

According to the augmented sample generation apparatus provided by this embodiment of the present disclosure, the at least two required parent samples are screened from the reference sample set to generate the new sample, and the first type of features and the second type of features included in the new sample are updated, thereby updating the different types of features and generating the augmented sample. Therefore, sample augmentation can be performed in conjunction with the different types of features, thereby ensuring diversity of the augmented sample, and further enhancing the classification training effect of the classification model.

The embodiments of the present invention further provide an electronic device, having the above augmented sample generation apparatus shown in FIG. 4.

Referring to FIG. 5, FIG. 5 is a structural schematic diagram of an electronic device according to an optional embodiment of the present invention. As shown in FIG. 5, the electronic device may include: one or more processors 10, a memory 20, as well as interfaces for connecting various components, including a high-speed interface and a low-speed interface. The various components are in mutual communication connection using different buses and may be installed on a common motherboard or installed in other methods as needed. The processor may process instructions executed within the electronic device, including instructions for graphic information stored in the memory or on the memory to display a graphical user interface (GUI) on an external input/output apparatus (e.g., a display device coupled to the interface). In some optional implementations, a plurality of processors and/or a plurality of buses may be used together with a plurality of memories as needed. Similarly, a plurality of electronic devices may be connected. Each electronic device provides some necessary operations (e.g., as a server array, a set of blade servers, or a multiprocessor system). One processor 10 is used as an example in FIG. 5.

The processor 10 may be a central processing unit, a network processor, or a combination thereof. The processor 10 may further include a hardware chip. The hardware chip may be an application specific integrated circuit, a programmable logic device, or a combination thereof. The programmable logic device may be a complex programmable logic device, a field-programmable gate array, a generic array logic, or any combination thereof.

The memory 20 stores instructions executable by at least one processor 10, such that the at least one processor 10 performs the method shown in the above embodiments.

The memory 20 may include a program storage area and a data storage area. The program storage area may store an operating system and an application required by at least one function. The data storage area may store data created based on the use of the electronic device. In addition, the memory 20 may include a high-speed random access memory, and may also include a non-transitory memory, such as at least one disk storage device, a flash memory device, or other non-transitory solid-state storage devices. In some optional implementations, the memory 20 optionally includes memories remotely set relative to the processor 10. These remote memories may be connected to the electronic device through a network. The examples of the above network include, but are not limited to, an Internet, an intranet, a local area network, a mobile communication network, and a combination thereof.

The memory 20 may include a volatile memory, such as a random access memory. The memory may also include a non-volatile memory, such as a flash memory, a hard drive, or a solid-state drive. The memory 20 may further include combinations of the above types of memories.

The electronic device further includes a communication interface 30, configured for data communication between the electronic device and other devices or communication networks.

The embodiments of the present invention further provide a computer-readable storage medium. The method according to the embodiments of the present invention may be implemented in hardware and firmware, or be implemented as computer code that is recordable on a storage medium, or is downloaded through the network and originally stored on a remote storage medium or a non-transitory machine-readable storage medium and then is stored on a local storage medium, and therefore the method described here may be processed by software that is stored on a storage medium using a general-purpose computer, a dedicated processor, or programmable or specialized hardware. The storage medium may be a magnetic disk, an optical disk, a read-only memory, a random access memory, a flash memory, a hard drive, a solid-state drive, or the like. Further, the storage medium may also include combinations of the above types of memories. It should be understood that a computer, a processor, a microprocessor controller, or programmable hardware includes a storage component that can store or receive software or computer code. When the software or computer code is accessed and executed by the computer, the processor, or the hardware, the method shown in the above embodiments is implemented.

Although the embodiments of the present invention are described in conjunction with the accompanying drawings, those skilled in the art may make various modifications and variations without departing from the spirit and scope of the present invention, and such modifications and variations fall within the scope defined by the appended claims.

1. A method for generating an augmented sample, comprising:
obtaining a reference sample set to be augmented, and selecting at least two parent samples from the reference sample set;
generating a new sample based on the at least two parent samples, wherein the new sample at least comprises a first type of features and a second type of features;
updating feature values of the first type of features based on first statistical data of the first type of features in the reference sample set, and updating classification options of the second type of features based on second statistical data of the second type of features in the reference sample set; and
generating an augmented sample based on the updated feature values of the first type of features and the updated classification options of the second type of features.

2. The method according to claim 1, wherein obtaining the reference sample set to be augmented comprises:
obtaining a classified sample set, wherein samples in the classified sample set have respective classification labels;
determining a target category to be augmented from various categories represented by the classification labels, and determining samples belonging to the target category from the classified sample set; and
generating the reference sample set to be augmented based on the samples belonging to the target category.

3. The method according to claim 1, wherein selecting the at least two parent samples from the reference sample set comprises:
determining a target number of parent samples to be selected, and determining classification fitness of each sample in the reference sample set; and
selecting the target number of parent samples from the reference sample set based on the classification fitness.

4. The method according to claim 3, wherein determining the classification fitness of each sample in the reference sample set comprises:
predicting, for any target sample in the reference sample set, the target sample based on a preset classification model to generate classification probability information indicating that the target sample is classified into a target category to be augmented, wherein the preset classification model is trained based on a classified sample set to which the reference sample set belongs; and
generating the classification fitness of the target sample based on the classification probability information.

5. The method according to claim 1, wherein generating the new sample based on the at least two parent samples comprises:
extracting respective part of sub-features from the parent samples, respectively, and constructing the new sample based on the extracted sub-features.

6. The method according to claim 1, wherein the first statistical data represents a statistical variance of the first type of features in the reference sample set; and
the step of updating the feature values of the first type of features specifically comprises:
constructing a normal distribution function based on the statistical variance, and generating noise values that conform to the normal distribution function randomly; and
superposing the noise value on the basis of original feature values of the first type of features to generate the updated feature values of the first type of features.

7. The method according to claim 1, wherein the second statistical data represents a distribution probability of each classification option of the second type of features in the reference sample set; and
the step of updating classification options of the second type of features specifically comprises:
replacing original classification options of the second type of features with target classification options based on the distribution probabilities, and using the target classification options as updated classification options of the second type of features.

8. The method according to claim 1, wherein the method further comprises, after generating the augmented sample:
determining classification fitness of the augmented sample, and in response to the classification fitness being less than a specified threshold, discarding the augmented sample; and in response to the classification fitness being greater than or equal to the specified threshold, adding the augmented sample to the reference sample set.

9. The method according to claim 8, wherein determining the classification fitness of the augmented sample comprises:
determining a target category corresponding to the reference sample set, and predicting the augmented sample based on a preset classification model to generate classification probability information indicating that the augmented sample is classified into the target category; and
generating the classification fitness of the augmented sample based on the classification probability information.

10. An electronic device, comprising a memory and a processor, wherein the memory is configured to store a computer program which, when executed by the processor, causes the processor to:
obtain a reference sample set to be augmented, and select at least two parent samples from the reference sample set;
generate a new sample based on the at least two parent samples, wherein the new sample at least comprises a first type of features and a second type of features;
update feature values of the first type of features based on first statistical data of the first type of features in the reference sample set, and update classification options of the second type of features based on second statistical data of the second type of features in the reference sample set; and
generate an augmented sample based on the updated feature values of the first type of features and the updated classification options of the second type of features.

11. The electronic device according to claim 10, wherein the computer program causing the processor to obtain the reference sample set to be augmented further causes the processor to:
obtain a classified sample set, wherein samples in the classified sample set have respective classification labels;
determine a target category to be augmented from various categories represented by the classification labels, and determine samples belonging to the target category from the classified sample set; and
generate the reference sample set to be augmented based on the samples belonging to the target category.

12. The electronic device according to claim 10, wherein the computer program causing the processor to select the at least two parent samples from the reference sample set further causes the processor to:
determine a target number of parent samples to be selected, and determine classification fitness of each sample in the reference sample set; and
select the target number of parent samples from the reference sample set based on the classification fitness.

13. The electronic device according to claim 12, wherein the computer program causing the processor to determine the classification fitness of each sample in the reference sample set further causes the processor to:
predict, for any target sample in the reference sample set, the target sample based on a preset classification model to generate classification probability information indicating that the target sample is classified into a target category to be augmented, wherein the preset classification model is trained based on a classified sample set to which the reference sample set belongs; and
generate the classification fitness of the target sample based on the classification probability information.

14. The electronic device according to claim 10, wherein the computer program causing the processor to generate the new sample based on the at least two parent samples further causes the processor to:
extract respective part of sub-features from the parent samples, respectively, and construct the new sample based on the extracted sub-features.

15. The electronic device according to claim 10, wherein the first statistical data represents a statistical variance of the first type of features in the reference sample set; and
the computer program causing the processor to update the feature values of the first type of features specifically further causes the processor to:
construct a normal distribution function based on the statistical variance, and generate noise values that conform to the normal distribution function randomly; and
superpose the noise value on the basis of original feature values of the first type of features to generate the updated feature values of the first type of features.

16. The electronic device according to claim 10, wherein the second statistical data represents a distribution probability of each classification option of the second type of features in the reference sample set; and
the computer program causing the processor to update classification options of the second type of features specifically further causes the processor to:
replace original classification options of the second type of features with target classification options based on the distribution probabilities, and use the target classification options as updated classification options of the second type of features.

17. The electronic device according to claim 10, wherein the computer program further causes the processor to, after generating the augmented sample:
determine classification fitness of the augmented sample, and in response to the classification fitness being less than a specified threshold, discard the augmented sample; and in response to the classification fitness being greater than or equal to the specified threshold, add the augmented sample to the reference sample set.

18. The electronic device according to claim 17, wherein the computer program causing the processor to determine the classification fitness of the augmented sample further causes the processor to:
determine a target category corresponding to the reference sample set, and predict the augmented sample based on a preset classification model to generate classification probability information indicating that the augmented sample is classified into the target category; and
generate the classification fitness of the augmented sample based on the classification probability information.

19. A non-transitory computer-readable storage medium for storing a computer program which, when executed by a processor, causes the processor to:
obtain a reference sample set to be augmented, and select at least two parent samples from the reference sample set;
generate a new sample based on the at least two parent samples, wherein the new sample at least comprises a first type of features and a second type of features;
update feature values of the first type of features based on first statistical data of the first type of features in the reference sample set, and update classification options of the second type of features based on second statistical data of the second type of features in the reference sample set; and
generate an augmented sample based on the updated feature values of the first type of features and the updated classification options of the second type of features.

20. The non-transitory computer-readable storage medium according to claim 19, wherein the computer program causing the processor to obtain the reference sample set to be augmented further causes the processor to:
obtain a classified sample set, wherein samples in the classified sample set have respective classification labels;
determine a target category to be augmented from various categories represented by the classification labels, and determine samples belonging to the target category from the classified sample set; and
generate the reference sample set to be augmented based on the samples belonging to the target category.
